(19) United States
(12) Patent Application Publication
(10) Pub. No.: US 2025/0178345 A1
(43) Pub. Date: Jun. 5, 2025

(54) LIQUID DISCHARGE HEAD, LIQUID DISCHARGE DEVICE, AND LIQUID DISCHARGE APPARATUS

(71) Applicants: Kazuto NAGAHASHI, KANAGAWA (JP); Keishi MIWA, KANAGAWA (JP)

(72) Inventors: Kazuto NAGAHASHI, KANAGAWA (JP); Keishi MIWA, KANAGAWA (JP)

(21) Appl. No.: 18/953,157

(22) Filed: Nov. 20, 2024

(30) Foreign Application Priority Data
Nov. 30, 2023 (JP) 2023-203030

(51) Int. Cl. B41J 2/14

(52) U.S. Cl. CPC B41J 2/14201; B41J 2002/14306

(57) ABSTRACT

A liquid discharge head includes a nozzle plate having nozzles, arrayed in a nozzle array direction, a channel substrate, and a holding substrate. The channel substrate has a first face bonded to the nozzle plate and a second face opposite the first face and includes partition walls, an end partition wall at an end of the channel substrate in the nozzle array direction, and individual channels partitioned by the partition walls and the end partition wall. The individual channels communicate with the respective nozzles. The holding substrate is bonded to the second face and has a first outer wall at an end of the holding substrate in the nozzle array direction. The end partition wall has a second outer wall at the end of the channel substrate in the nozzle array direction. The second outer wall is interior of the first outer wall in the nozzle array direction.

### CROSS-REFERENCE TO RELATED APPLICATIONS

This patent application is based on and claims priority pursuant to 35 U.S.C. § 119(a) to Japanese Patent Application No. 2023-203030, filed on Nov. 30, 2023, in the Japan Patent Office, the entire disclosure of which is hereby incorporated by reference herein.

### BACKGROUND

### Technical Field

Embodiments of the present disclosure relate to a liquid discharge head, a liquid discharge device, and a liquid discharge apparatus.

### Related Art

A liquid discharge head is known that is employed for an inkjet-type image forming apparatus. The liquid discharge head includes a channel substrate, a piezoelectric element holding substrate, a damper, and a damper holding substrate. The channel substrate defines individual liquid chambers communicating with respective nozzles. The piezoelectric element holding substrate is bonded to the liquid chamber substrate on a side opposite a nozzle plate having nozzles. The piezoelectric element holding substrate defines recesses each accommodating a piezoelectric element. The damper dissipates vibration energy to dampen impact or amplitude of vibration. The damper holding substrate defines a space in which the damper vibrates. The above-described components are bonded to each other by, for example, an adhesive.

In a liquid discharge device in which the above-described liquid discharge heads with the nozzles arranged at a high density, are adjacently arranged, preferably, a gap between the liquid discharge heads is set as narrow as possible to reduce unevenness of image density from being generated. For this reason, for example, the nozzles and the liquid chambers are positioned in the vicinity of the end of the liquid discharge head.

In view of this, a configuration is known in which thin plates are laminated one on another. Such a configuration can efficiently release, for example, an adhesive and air bubbles while ensuring the rigidity of the thin plates to reduce occurrence of warping of the thin plates. In such a configuration in which multiple thin plates are laminated one on another with an adhesive, at least one groove is formed in a short direction of a bonding surface of a thin plate to another thin plate, and at least one of both ends of the groove is formed to have a length not reaching an end of the thin plate.

Further, a liquid discharge head is known that includes a pressurizing liquid chamber forming member. A pressurizing liquid chamber pattern is formed on a pressurizing liquid chamber forming surface of the pressurizing liquid chamber forming member, and a dummy pattern is formed on an surface of the pressurizing liquid chamber forming member facing the pressurizing liquid chamber forming surface in parallel to a longitudinal direction of the pressurizing liquid chamber pattern and in a zigzag manner with respect to the dummy pattern adjacent to the pressurizing liquid chamber pattern.

In addition, a liquid discharge apparatus is known that includes a reinforcing layer and a channel partition wall. The reinforcing layer is disposed at a position corresponding to a channel partition wall on a diaphragm, and the width of a lower surface of the reinforcing layer on the diaphragm is wider than the width of an upper portion of the reinforcing layer.

### SUMMARY

In an embodiment of the present disclosure, a liquid discharge head includes a nozzle plate having multiple nozzles, arrayed in a nozzle array direction, to discharge droplets, a channel substrate, and a holding substrate. The channel substrate has a first face bonded to the nozzle plate and a second face opposite to the first face and includes partition walls, an end partition wall at an end of the channel substrate in the nozzle array direction, and multiple individual channels partitioned by the partition walls and the end partition wall. The multiple individual channels respectively communicate with the respective multiple nozzles. The holding substrate is bonded to the second face of the channel substrate. The holding substrate has a first outer wall at an end of the holding substrate in the nozzle array direction. The end partition wall has a second outer wall at the end of the channel substrate in the nozzle array direction. The second outer wall of the channel substrate is interior of the first outer wall of the holding substrate in the nozzle array direction.

In another embodiment of the present disclosure, a liquid discharge device includes the liquid discharge head.

In still another embodiment of the present disclosure, a liquid discharge apparatus includes the liquid discharge device.

In still another embodiment of the present disclosure, a liquid discharge apparatus includes the liquid discharge head.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic exploded perspective view of a liquid discharge device including multiple liquid discharge heads according to a comparative example and embodiments of the present disclosure as viewed from a nozzle face side of the liquid discharge device;

FIG. 2 is a schematic cross-sectional view of a liquid discharge device according of FIG. 1, taken along a short-side direction of the liquid discharge heads;

FIG. 3 is a schematic cross-sectional view of a portion of the liquid discharge head between a channel substrate and a common channel frame, according to a comparative example;

FIG. 4A is a schematic perspective view of a liquid discharge head with a nozzle plate 10 facing downward, according to a comparative example;

FIG. 4B is a schematic perspective plan view of the nozzle plate of FIG. 4A as viewed from the lower surface of the nozzle plate;

FIG. 4C is a schematic perspective plan view of a channel substrate as viewed from the lower surface of the channel substrate;

FIG. 5 is a cross-sectional view of the liquid discharge head of FIG. 4A, taken along the line A-A of FIG. 4B;

FIG. 6A is a schematic perspective view of the liquid discharge head with a nozzle plate facing downward, according to a first embodiment of the present disclosure;

FIG. 6B is a schematic plan view of the nozzle plate of FIG. 6A as viewed from below;

FIG. 6C is a schematic plan view of a channel substrate of the liquid discharge head of FIG. 6A, viewed from below;

FIG. 7 is a cross-sectional view of the liquid discharge head of FIG. 6B, taken along line B-B in FIG. 6B;

FIG. 8A is a schematic perspective view of a liquid discharge head with a nozzle plate facing downward, according to a second embodiment of the present disclosure;

FIG. 8B is a schematic plan view of the nozzle plate of FIG. 8A viewed from below;

FIG. 8C is a schematic plan view of a channel substrate of the liquid discharge head of FIG. 8A, viewed from below;

FIG. 9 is a table illustrating results of a comparison test that compares the liquid discharge heads according to embodiments of the present disclosure and a liquid discharge head according to a comparative example;

FIG. 10 is a schematic front view of a liquid discharge apparatus including the liquid discharge head according to embodiments of the present disclosure;

FIG. 11 is a schematic plan view of a liquid discharge device of the liquid discharge apparatus including the liquid discharge head according to embodiments of the present disclosure;

FIG. 12 is a schematic plan view of another liquid discharge apparatus including the liquid discharge head according to embodiments of the present disclosure;

FIG. 13 is a schematic side view of the liquid discharge apparatus of FIG. 12, including the liquid discharge head according to embodiments of the present disclosure;

FIG. 14 is a schematic plan view of a liquid discharge device of another liquid discharge apparatus including the liquid discharge head according to embodiments of the present disclosure;

FIG. 15 is a schematic front view of another liquid discharge device of another liquid discharge apparatus including the liquid discharge head according to embodiments of the present disclosure; and

FIG. 16 is a schematic front view of an electrode manufacturing apparatus as still another liquid discharge apparatus including the liquid discharge head according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

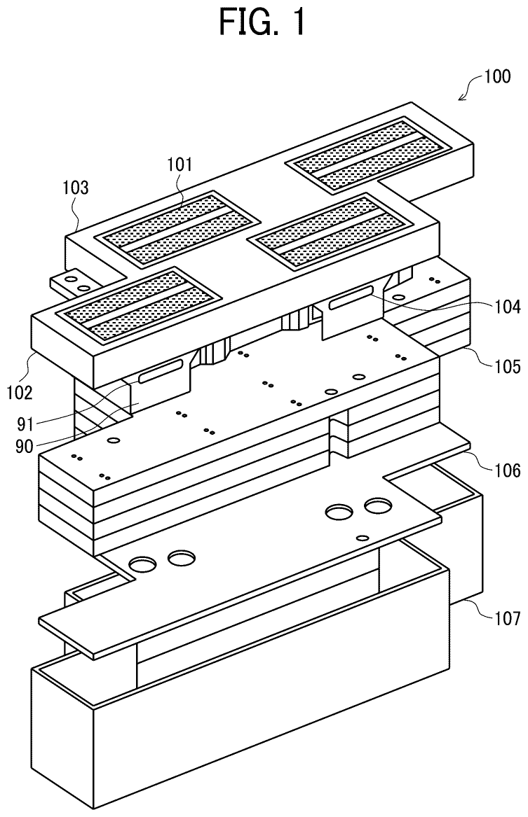

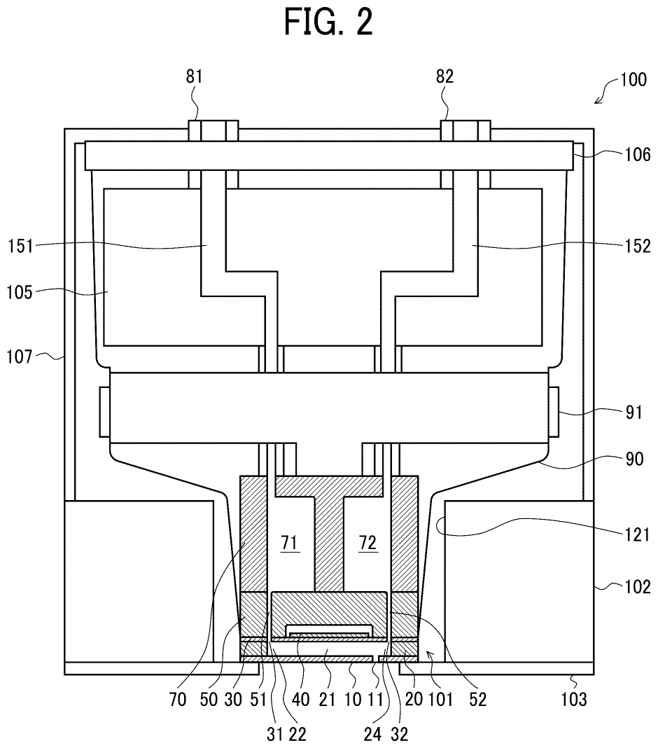

FIG. 1 is a schematic exploded perspective view of a liquid discharge device 100 including multiple liquid discharge heads 101 according to a comparative example and embodiments of the present disclosure as viewed from a nozzle face side of the liquid discharge device 100. FIG. 2 is a schematic cross-sectional view of the liquid discharge device 100, taken along a short-side direction of the liquid discharge heads 101 of the liquid discharge device 100. In FIG. 1, the liquid discharge device 100 includes the multiple liquid discharge heads 101 to discharge liquid, a base 102 to hold the multiple liquid discharge heads 101, and a cover 103 serving as a nozzle cover to cover the multiple liquid discharge heads 101. The liquid discharge device 100 further includes a heat dissipator 104, a manifold 105 defining channels to supply the liquid to the multiple liquid discharge heads 101, a printed circuit board (PCB) 106 coupled to a flexible wiring 90 including a driver integrated circuit (IC) 91, and a module case 107.

Each of the multiple liquid discharge heads 101 includes a nozzle plate 10, a channel substrate 20, a diaphragm 30, a piezoelectric element holding substrate 50, and a common channel frame 70. The nozzle plate 10 has multiple nozzles 11, arrayed in a nozzle array direction, to discharge droplets. The channel substrate 20 defines individual chambers 21 serving as pressure chambers communicating with the nozzles 11, respectively. The diaphragm 30 includes piezoelectric elements 40. The piezoelectric element holding substrate 50 is laminated over the diaphragm 30. The common channel frame 70 is laminated over the piezoelectric element holding substrate 50.

A material of the nozzle plate 10 is a single-crystal silicon wafer. In addition to the individual chambers 21 that serve as individual channels communicating with the respective nozzles 11, the channel substrate 20 defines supply-side individual channels 22 communicating with the individual chambers 21 and collection-side individual channels 24 communicating with the individual chambers 21, respectively.

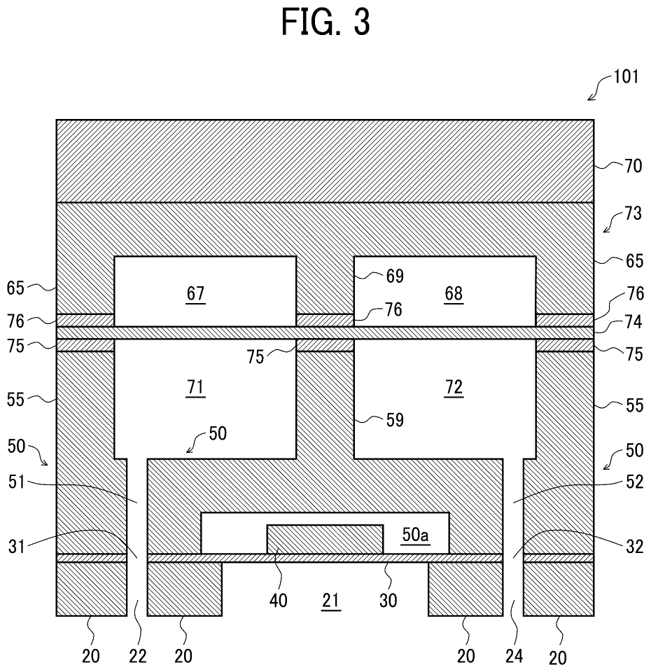

A material of the piezoelectric element holding substrate 50 is a single-crystal silicon wafer. The piezoelectric element holding substrate 50 defines supply-side intermediate individual channels 51 and collection-side intermediate individual channels 52. The supply-side intermediate individual channels 51 communicate with the supply-side individual channels 22 via openings 31, respectively, of the diaphragm 30. The collection-side intermediate individual channels 52 communicate with the collection-side individual channels 24 via openings 32, respectively, of the diaphragm 30. As illustrated in FIG. 3, the piezoelectric element holding substrate 50 defines a recess 50a to accommodate the piezoelectric elements 40.

The piezoelectric element holding substrate 50 and the common channel frame 70 defines a supply-side common channel 71 and a collection-side common channel 72. The supply-side common channel 71 communicates with the supply-side intermediate individual channels 51. The collection-side common channel 72 communicates with the collection-side intermediate individual channels 52.

The supply-side common channel 71 communicates with a supply port 81 via a channel 151 of the manifold 105, and the collection-side common channel 72 communicates with a collection port 82 via a channel 152 of the manifold 105.

The PCB 106 and the piezoelectric elements 40 are connected to each other via the flexible wiring 90, and the driver IC 91 is mounted on the flexible wiring 90.

In the present embodiment, the multiple liquid discharge heads 101 are attached to the base 102 at predetermined intervals. The liquid discharge head 101 is inserted into an opening 121 in the base 102, and the peripheral end of the nozzle plate 10 of the liquid discharge head 101 is bonded and fixed to the cover 103, which is bonded and fixed to the base 102, to attach the liquid discharge head 101 to the base 102.

A flange disposed outside the common channel frame 70 of the liquid discharge head 101 is bonded and fixed to the base 102. A structure that fixes the head 101 to the base 102 is not limited to the above-described structure. The liquid discharge head 101 may be fixed to the base 102 by, for example, bonding, swaging, riveting, or screwing.

In the present embodiment, the base 102 is preferably formed of a material having a low coefficient of linear expansion. Examples of the material having the low coefficient of linear expansion include an alloy 42 in which nickel is added to iron and an invar material. In the comparative example and the present embodiment, the invar material is used.

With such a configuration, even if the temperature of the base 102 is increased by heat generated by the liquid discharge head 101, the amount of thermal expansion of the base 102 is small. Accordingly, the liquid discharge head 101 can reduce displacement of the nozzles 11 from predetermined nozzle positions to reduce deviation of landing positions of liquid droplets discharged from the nozzles 11 of the liquid discharge head 101.

Similarly, the nozzle plate 10, the channel substrate 20, and the diaphragm 30 are formed of a silicon single-crystal substrate and have substantially a same coefficient of linear expansion as the coefficient of linear expansion of the base 102. This configuration can reduce the displacement of the nozzles 11 caused by thermal expansion of the above-described components.

FIG. 3 is a schematic cross-sectional view of a portion of the liquid discharge head 101 between the channel substrate 20 and the common channel frame 70, according to a comparative example.

In FIG. 3, the common channel frame 70 includes a damper 74 at a lower portion thereof. The damper 74 dampens impact and vibration of the liquid. The damper 74 is preferably formed of a thin metal film or an inorganic thin film which is resistant to an organic solvent, and the thickness thereof is preferably 10 μm or less. One face (i.e., a first face) of the damper 74 is bonded to the piezoelectric element holding substrate 50 via an adhesive 75, and the other face (i.e., a second face) of the damper 74 is bonded to a damper holding substrate 73 of the common channel frame 70 via an adhesive 76. In other words, the common channel frame 70 includes the damper holding substrate 73 bonded to the damper 74, and a material of the damper holding substrate 73 is a single-crystal silicon wafer. The adhesive 75 is selected as the most suitable adhesive for bonding the damper 74 and the piezoelectric element holding substrate 50, and the adhesive 76 is selected as the most suitable adhesive for bonding the damper 74 and the damper holding substrate 73. The adhesive 75 and the adhesive 76 are made of, for example, a thermosetting resin.

The damper holding substrate 73 and the damper 74 may be manufactured by using a semiconductor manufacturing process. In this case, a material of the damper 74 is deposited on a wafer serving as a substrate. A surface of the wafer is bonded to the damper holding substrate 73 on which a space is formed by patterning. The damper 74 vibrates in the space.

The piezoelectric element holding substrate 50 includes a partition wall 59 as a first partition that separates the supply-side common channel 71 and the collection-side common channel 72. The damper 74 vibrates in the supply-side common channel 71 and the collection-side common channel 72 which are referred to as first side spaces. The piezoelectric element holding substrate 50 further includes side walls 55 disposed at both ends thereof in FIG. 3. The side walls 55 have the same width as the partition wall 59.

The damper holding substrate 73 has a partition wall 69 as a second partition that separates a space 67 and a side space 68. The side space 67 is opposed to the supply-side common channel 71. The side space 68 is opposed to the collection-side common channel 72. The damper 74 vibrates in the side spaces 67 and 68. The damper holding substrate 73 further includes side walls 65 disposed at both ends thereof in FIG. 3. The side walls 65 have the same width as the partition wall 69.

The first face of the damper 74 is bonded to the side walls 55 and the partition wall 59 with the adhesive 75, and the second face of the damper 74 is bonded to the side walls 65 and the partition wall 69 with the adhesive 76.

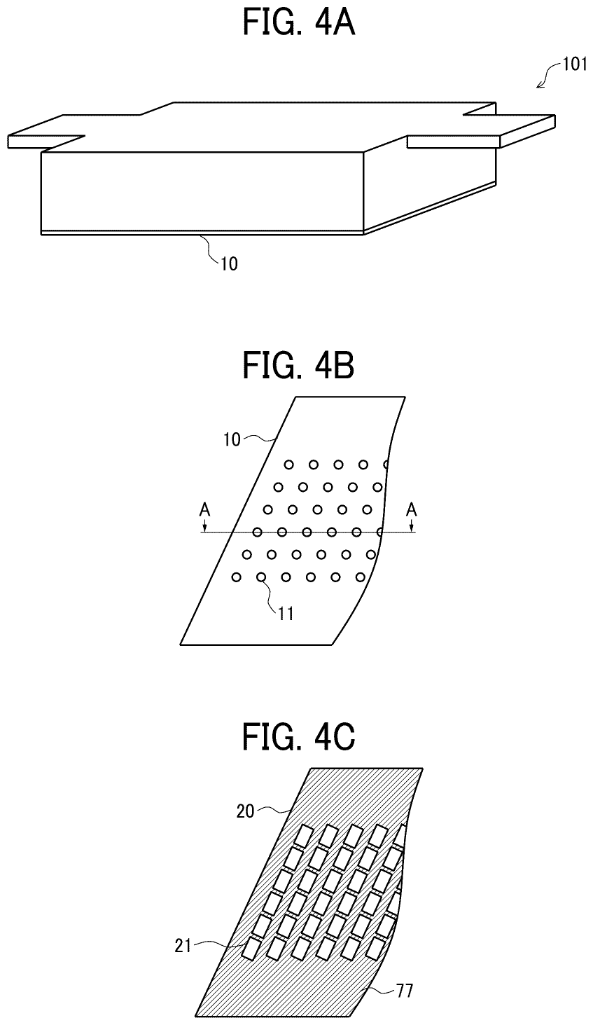

FIG. 4A is a schematic perspective view of the liquid discharge head 101 with the nozzle plate 10 facing downward. FIG. 4B is a schematic perspective plan view of the nozzle plate 10 as viewed from the lower surface of the nozzle plate 10. FIG. 4C is a schematic perspective plan view of the channel substrate 20 as viewed from the lower surface of the channel substrate 20. As illustrated in FIGS. 4B and 4C, the multiple nozzles 11 are regularly formed on the nozzle plate 10, and the multiple individual chambers 21 are formed at positions corresponding to the respective nozzles 11 on the channel substrate 20. In the liquid discharge head 101 of the comparative example illustrated in FIGS. 4A, 4B, and 4C, an adhesive 77 is applied to a hatched portion (FIG. 4C) of the channel substrate 20 to bond and fix the channel substrate 20 and the nozzle plate 10 to each other.

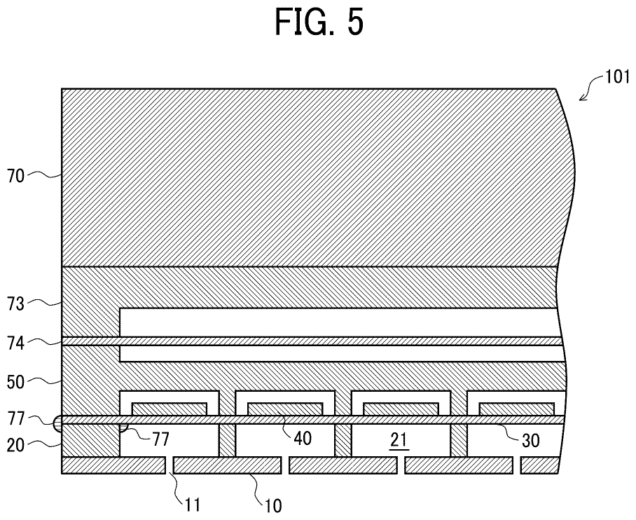

FIG. 5 is a cross-sectional view of the liquid discharge head 101, taken along the line A-A of FIG. 4B. As illustrated in FIG. 5, the nozzle plate 10 and the channel substrate 20 each has a face forming a same plane as a part of the outer wall (the left side of FIG. 5) of the liquid discharge head 101. Accordingly, the channel substrate 20 may be deformed or damaged when an external force is applied. As a result, for example, leakage of liquid, disconnection of wiring, change in channel volume, may occur. Thus, desired functions of the liquid discharge head 101 cannot be obtained. As described above, the adhesive 77 is applied to the channel substrate 20 to bond and fix the channel substrate 20 and the nozzle plate 10 to each other and the adhesive 77 is heated and cured while the channel substrate 20 and the nozzle plate 10 are pressed from above and below. However, when the channel substrate 20 and the nozzle plate 10 are pressed, the adhesive 77 extends off from between the nozzle plate 10 and the channel substrate 20 to the outside. Thus, the protruded adhesive 77 that has extended off to the outside interferes with an adjacent liquid discharge head 101. A side of the channel substrate 20 that is bonded to the nozzle plate 10 may also be referred to simply as a first face in the following description. A face of the channel substrate 20 opposite the first face may also be referred to simply as a second face in the following description.

A description is given of a configuration of an embodiment of the present disclosure that prevents the above-described disadvantages from occurring.

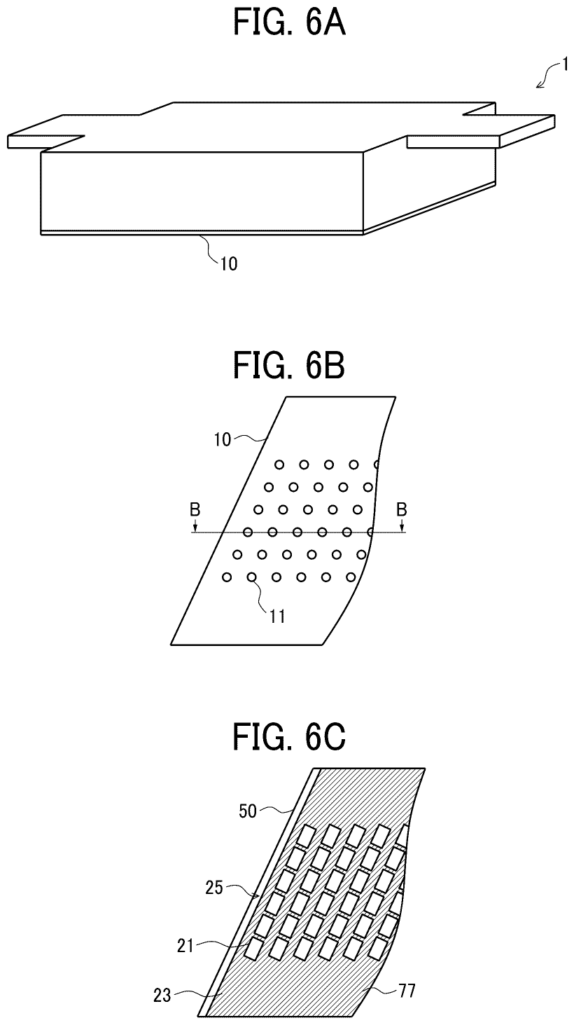

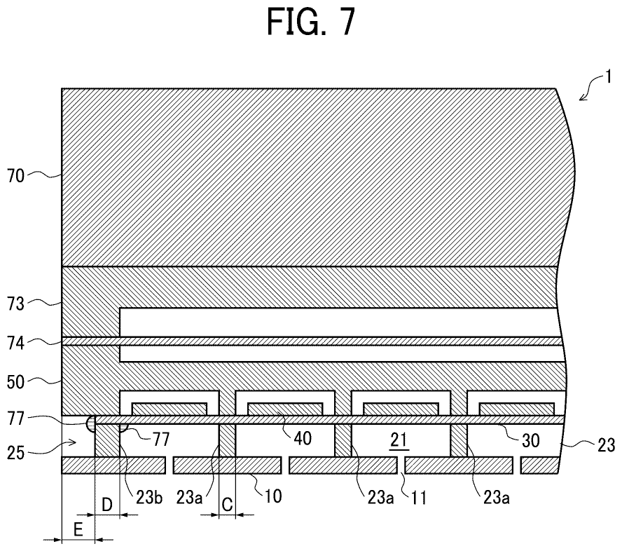

FIG. 6A is a schematic perspective view of a liquid discharge head 1 with the nozzle plate 10 facing downward, according to a first embodiment of the present disclosure. FIG. 6B is a schematic plan view of the nozzle plate 10 viewed from the lower surface of the nozzle plate 10. FIG. 6C is a schematic plan view of the channel substrate 23 viewed from the lower surface of the channel substrate 20. FIG. 7 is a cross-sectional view of the liquid discharge head 1, taken along line B-B in FIG. 6B. The liquid discharge head 1 is different from the above-described liquid discharge head 101 in that the liquid discharge head 1 includes the channel substrate 23 as a second partition instead of the channel substrate 20. The other configurations are the same as that of the liquid discharge head 101.

As illustrated in FIG. 7, the channel substrate 23 includes multiple partition walls which form the individual chambers 21 which are multiple individual channels. Each of the individual chambers 21 includes a partition wall 23a disposed at a position other than a position at the end of the channel substrate 23 in the longitudinal direction in FIG. 6A, and an end partition wall 23b disposed at the end of the channel substrate 23 in the longitudinal direction.

The end partition wall 23b is formed such that the outer wall of the end partition wall 23b is positioned at an inner position than the outer wall of one end of the piezoelectric element holding substrate 50. The end partition wall 23b defines a recess 25 between the nozzle plate 10 and the piezoelectric element holding substrate 50 together with the diaphragm 30.

The liquid discharge head 1 of the present embodiment includes the recess 25. By so doing, the outer wall of the channel substrate 23 is positioned inside the outer wall of the liquid discharge head 1. Accordingly, the outer wall of the channel substrate 23 is prevented from directly receiving an external force. Such a configuration as described above can prevent disadvantages in which the desired functions of the liquid discharge head 101 cannot be obtained, from occurring when, for example, the channel substrate 23 is deformed, liquid leaks, wires are disconnected, and channel volume changes.

In addition, when the channel substrate 23 and the piezoelectric element holding substrate 50 are bonded to each other with pressure via the diaphragm 30, the adhesive 77 that has extended off while the channel substrate 23 and the piezoelectric element holding substrate 50 are pressed, remains in the recess 25. Accordingly, a disadvantage in which the adhesive 77 that has extended off interferes with an adjacent liquid discharge head 1 can be prevented.

In the liquid discharge head 1, as illustrated in FIG. 7, the channel substrate 23 is formed such that a width D of the end partition wall 23b is larger than a width C of the partition walls 23a. Such a configuration as described above can prevent crosstalk from occurring when droplets are discharged, and reduce variation in discharge performance to enhance image quality.

In the liquid discharge head 1, a distance E between the outer wall of one end of the piezoelectric element holding substrate 50 and the outer wall of the end partition wall 23b is equal to or larger than the width D of the end partition wall 23b.

Such a configuration as described above can secure a distance from the outer surface of the liquid discharge head 1 to the individual chambers 21 which are the individual channels. Accordingly, a risk of leakage of the liquid can be prevented when chipping or cracking occurs in the end partition wall 23b due to an external force.

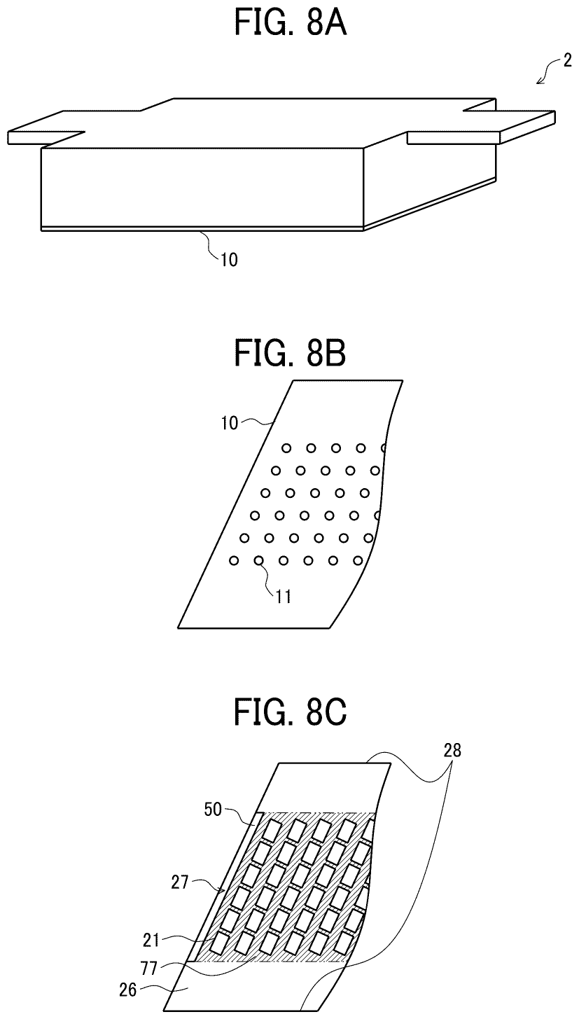

FIG. 8A is a schematic perspective view of a liquid discharge head 2 with the nozzle plate 10 facing downward, according to a second embodiment of the present disclosure. FIG. 8B is a schematic plan view of the nozzle plate 10 viewed from below. FIG. 8C is a schematic plan view of a channel substrate 26 viewed from below. The liquid discharge head 2 is different from the liquid discharge head 1 in that the channel substrate 26 is used instead of the channel substrate 23. The other configurations are the same as that of the liquid discharge head 101.

The channel substrate 26 includes a partition wall disposed at a position other than a position at the end of the channel substrate 26 in the longitudinal direction and an end partition wall disposed at the end of the channel substrate 26 in the longitudinal direction. The end partition wall is formed such that the outer wall of the end partition wall is positioned at an inner position than an outer wall of the piezoelectric element holding substrate 50. The end partition wall defines a recess 27 between the nozzle plate 10 and the piezoelectric element holding substrate 50 together with the diaphragm 30.

The recess 27 is formed between the nozzle plate 10 and the piezoelectric element holding substrate 50 together with the diaphragm 30, and is not formed in the vicinity of both ends of the channel substrate 26 in the short-side direction and of the other side intersecting the one side in the short direction of the channel substrate 26, similarly to the recess 25. The adhesive 77 is not applied to portions in the vicinity of the both ends on the other side of the channel substrate 26.

In the second embodiment, the channel substrate 20 has a third outer wall 28 at each end of the channel substrate 20 outside the second outer wall in a short direction intersecting the nozzle array direction, and the third outer wall is disposed at the same position as the first outer wall of the piezoelectric element holding substrate 50 in the nozzle array direction. In other words, the outer wall of the one side end of the channel substrate 26 is formed with the recess 27 only at the portion corresponding to the outer wall. Such a configuration as described above allows a recessed portion to be formed on the outer peripheral surface of the channel substrate 23. By so doing, a portion of the outer peripheral surface of the channel substrate 23, which has a reduced thickness, thus structurally weak, can be minimized. Accordingly, prevent chipping or cracking can be prevented from progressing to the individual chamber 21 while maintaining strength of the outer peripheral surface of the channel substrate 23. At the same time, the adhesive 77 that is applied to the periphery of the individual chamber 21 can be prevented from extending off to the outside of the channel substrate 23.

Next, a description is given of a comparison test of the liquid discharge heads 1, 2, and 101 described above. In the comparison test, chipping and cracking of the channels and extension of the adhesives were evaluated.

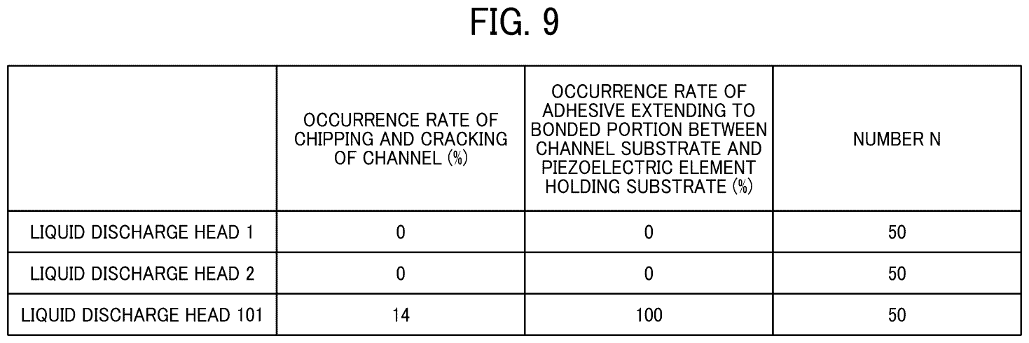

In the evaluation of chipping and cracking of the channel, it was evaluated whether chipping and cracking reached the channel from the outer peripheral surface of the channel substrate 23 when the assembly process of the liquid discharge heads 1, 2, and 101 including contacting the outer periphery abutting was performed in the configuration of each liquid discharge head. Whether the chipping or cracking reaches the channel was confirmed by observation with an infrared (IR) microscope. The results of the comparison test are illustrated in FIG. 9.

The occurrence rate of chipping and cracking of the channel in the liquid discharge heads 1 and 2 was lower than in the liquid discharge head 101. It is considered that, in the liquid discharge head 101 of the comparative example, chipping occurred in the outer periphery of the channel substrate 23 due to a load applied from an external force, and the generated chipping extended to the inner side of the channel substrate 23. By contrast, in the liquid discharge heads 1 and 2, the recess 25 and 27 caused an external force to be less likely to act on the outer periphery of the channel substrate 23, and even when chipping occurred in the outer periphery, the chipping stopped extending and did not reach the channel substrate 23.

In the evaluation of the extending off of the adhesive, it was evaluated whether the adhesive extended off from the outer periphery of the channel substrate 23 when the assembly process of the liquid discharge heads 1, 2, and 101 including the bonding process using the adhesive was performed in the configuration of each of the liquid discharge head 1, 2, and 101. The results of the comparison test are illustrated in FIG. 9.

The rate of occurrence of the adhesive extending off to the outer periphery of the circuit board was lower in the liquid discharge heads 1 and 2 than in the liquid discharge head 101. This is considered as follows. The adhesive was applied up to the outer periphery of the channel substrate 23 in the liquid discharge head 101 of the comparative example, the adhesive was squeezed out by the pressure applied when the channel substrate 20 and the nozzle plate 10 are bonded and pressed to each other. By contrast, the squeezed out adhesive stayed in the recess 25 and 27 and did not extend off to the outer periphery of the channel substrate 23 in the liquid discharge heads 1 and 2 because of the recess 25 and 27.

From the above results, it can be said that the liquid discharge heads 1 and 2 of the present embodiments are superior to the liquid discharge head 101 of the comparative example in terms of the occurrence of chipping and cracking of the channel due to the load of the external force from the outer periphery of the circuit board and the adhesive extended off.

In the liquid discharge head 1, although there was no chipping or cracking reaching the channel, it was observed that the outer periphery was chipped at multiple locations. For this reason, in consideration of the influence of the generation of foreign matter due to chipping, desirably, the recess 27 is disposed in a limited portion of the outer periphery of the circuit board to prevent unexpected chipping or cracking from occurring, as in the liquid discharge head 2.

A liquid discharge apparatus including the above-described liquid discharge head 1 or 2 is described below.

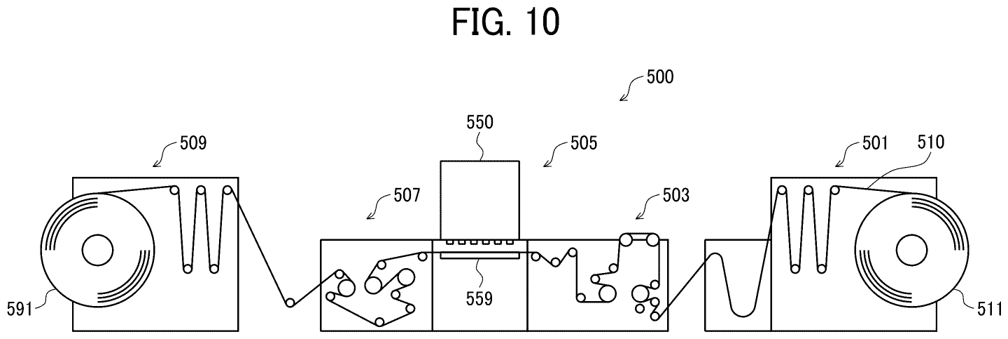

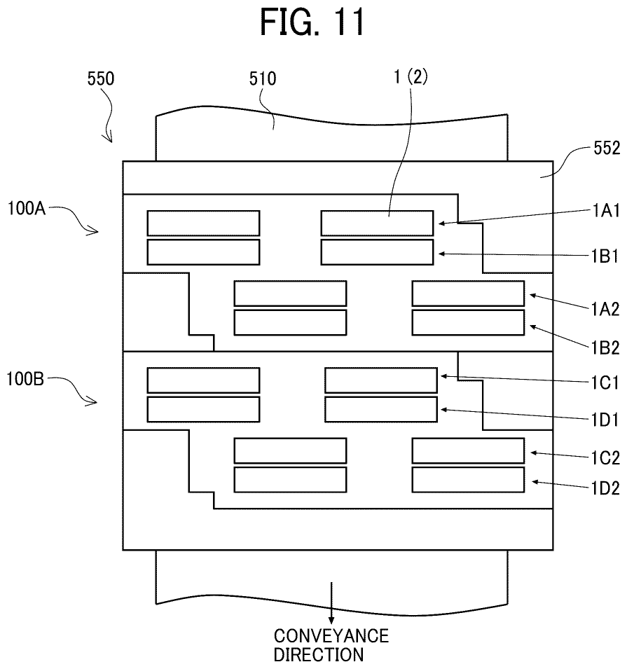

As illustrated in FIGS. 10 and 11, a printer 500 that serves as the liquid discharge apparatus includes a feeder 501 to feed a continuous medium 510 as a recording medium, a guide conveyor 503 to guide and convey the continuous medium 510, fed from the feeder 501, to a printing unit 505. The printer 500 further includes the printing unit 505 to discharge a liquid onto the continuous medium 510 to form an image on the continuous medium 510, a dryer 507 to dry the continuous medium 510 to which the liquid adheres, and a carrier 509 to feed the dried continuous medium 510 outward.

The continuous medium 510 is fed from a winding roller 511 of the feeder 501, guided and conveyed with rollers of the feeder 501, the guide conveyor 503, the dryer 507, and the carrier 509, and wound around a take-up roller 591 of the carrier 509. These rollers serve as a conveyor to convey the continuous medium 510.

In the printing unit 505, the continuous medium 510 is conveyed on a conveyance guide 559 so as to face a head unit 550 as a liquid discharge device. The head unit 550 discharges a liquid onto the continuous medium 510 to print an image.

The printer 500 includes liquid discharge devices 100A and 100B, which are similar to the above-described liquid discharge device 100, in the head unit 550. The liquid discharge devices 100A and 100B are mounted on a common base 552.

The liquid discharge device 100A includes head arrays 1A1, 1B1, 1A2, and 1B2. Each of the head arrays 1A1, 1B1, 1A2, and 1B2 includes multiple liquid discharge heads 1 arranged in a head array direction perpendicular to a conveyance direction of the continuous medium 510. The liquid discharge device 100B includes head arrays 1C1, 1D1, 1C2, and 1D2. Each of the head arrays 1C1, 1D1, 1C2, and 1D2 includes multiple liquid discharge heads 1 arranged in the head array direction perpendicular to the conveyance direction of the continuous medium 510. The head arrays 1A1 and 1A2 of the liquid discharge device 100A discharge liquid of the same color. Similarly, the head arrays 1B1 and 1B2 of the liquid discharge device 100A are grouped as one set and discharge liquid of the same desired color. The head arrays 1C1 and 1C2 of the liquid discharge device 100B are grouped as one set and discharge liquid of the same desired color. The head arrays 1D1 and 1D2 of the liquid discharge device 100B are grouped as one set and discharge liquid of the same desired color.

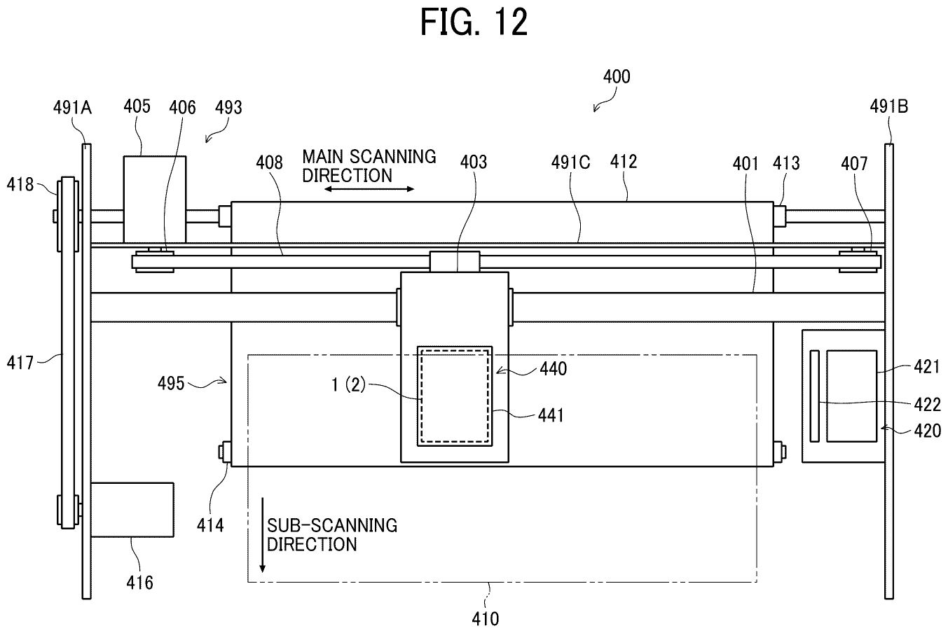

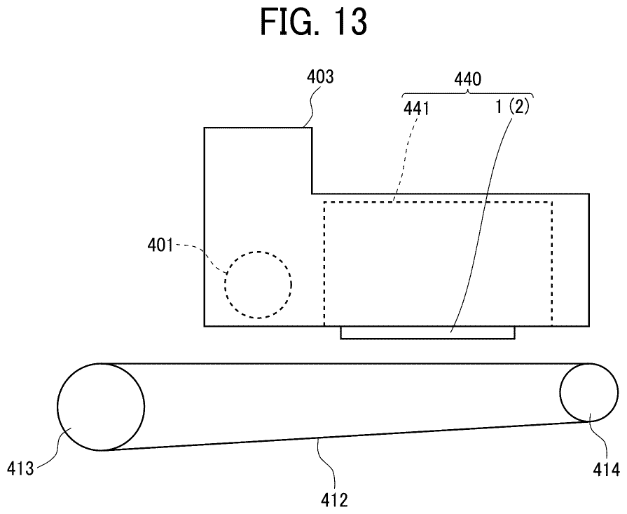

Another printer 400 as a liquid discharge apparatus according to the present embodiment is described below with reference to FIGS. 12 and 13.

As the liquid discharge apparatus, the printer 400 is a serial type printing apparatus, and a main-scanning moving mechanism 493 reciprocally moves a carriage 403 in a main scanning direction. The main-scanning moving mechanism 493 includes a guide 401, a main scanning motor 405, and a timing belt 408. The guide 401 is bridged between a left side plate 491A and a right side plate 491B to movably hold the carriage 403. The carriage 403 is reciprocally moved in the main scanning direction by driving force of the main scanning motor 405 transmitted via the timing belt 408 looped around a drive pulley 406 and a driven pulley 407.

The carriage 403 mounts a liquid discharge device 440 including the liquid discharge head 1 and a head tank 441 as a single integrated unit. The liquid discharge head 1 discharges color liquid of, for example, yellow (Y), cyan (C), magenta (M), and black (K). The liquid discharge head 1 is mounted on the liquid discharge device 440 such that a nozzle row including the multiple nozzles 11 is arranged in a sub-scanning direction perpendicular to the main scanning direction. The liquid discharge head 1 discharges the color liquid downward from the multiple nozzles 11. The liquid discharge head 1 is coupled to a liquid circulation device so that a liquid of a desired color is circulated and supplied to the liquid discharge head 1.

The printer 400 includes a conveyance mechanism 495 to convey a sheet 410 as the recording medium. The conveyance mechanism 495 includes a conveyance belt 412 as a conveyor and a sub-scanning motor 416 to drive the conveyance belt 412. The conveyance belt 412, which is an endless belt, is stretched between a conveyance roller 413 and a tension roller 414, and conveys the sheet 410 at a position facing the liquid discharge head 1 while attracting the sheet 410. The sheet 410 can be attracted to the conveyance belt 412 by, for example, electrostatic attraction or air suction. The conveyance belt 412 is circumferentially moved in the sub-scanning direction by driving force of the sub-scanning motor 416 transmitted via a timing belt 417 and a timing pulley 418.

On one end of the range of movement of the carriage 403 in the main scanning direction, a maintenance mechanism 420 that maintains and recovers the liquid discharge head 1 is disposed lateral to the conveyance belt 412. The maintenance mechanism 420 includes, for example, a cap 421 to cap a nozzle face (i.e., a face on which the multiple nozzles 11 are formed) of the liquid discharge head 1 and a wiper 422 to wipe the nozzle face. The main-scanning moving mechanism 493, the maintenance mechanism 420, and the conveyance mechanism 495 are mounted onto a housing including the left side plate 491A and the right side plate 491B and a back plate 491C.

In the printer 400 having the above-described configuration, the sheet 410 is attracted on the conveyance belt 412 and conveyed in the sub-scanning direction by the circumferential movement of the conveyance belt 412. The liquid discharge head 1 is driven in response to an image signal while the carriage 403 moves in the main scanning direction to discharge a liquid onto the sheet 410 not in motion. As a result, an image is formed on the sheet 410.

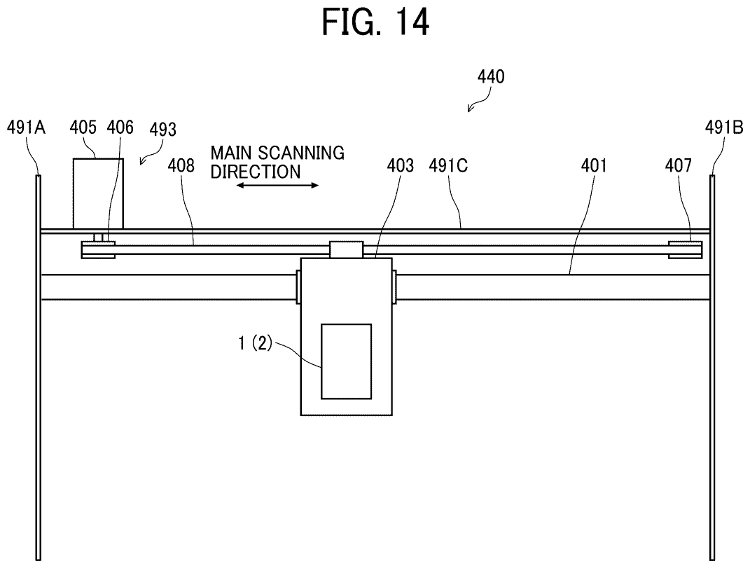

The above-described liquid discharge device 440 is described below with reference to FIG. 14.

The liquid discharge device 440 includes the housing, the main-scanning moving mechanism 493, the carriage 403, and the liquid discharge head 1 among components of the printer 400 as the liquid discharge apparatus. The the left side plate 491A and the right side plate 491B, and the back plate 491C construct the housing.

In the liquid discharge device 440, the maintenance mechanism 420 described above may be mounted on, for example, the side plate 491B.

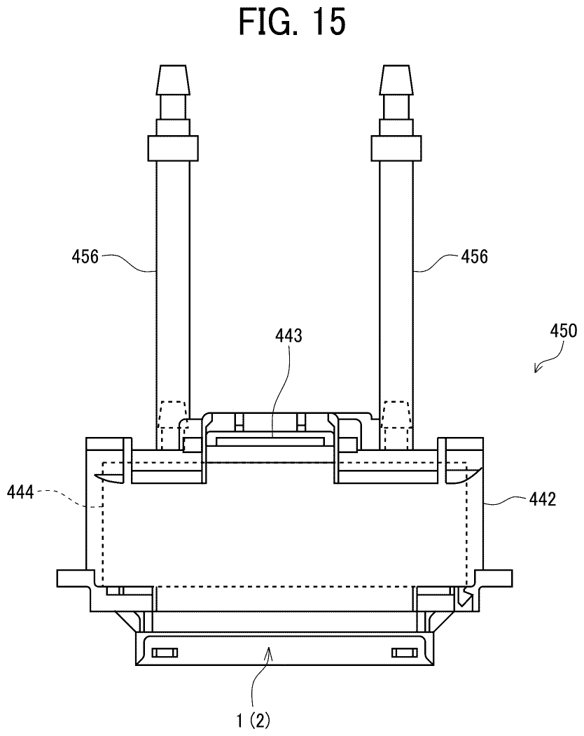

Another liquid discharge device 450 according to the embodiments of the present disclosure is described below with reference to FIG. 15.

The liquid discharge device 450 illustrated in FIG. 15 includes the liquid discharge head 1 to which a channel component 444 is attached, and a tube 456 connected to the channel component 444. The channel component 444 is disposed inside a cover 442, and a connector 443 for electrically connecting to the liquid discharge head 1 is provided on an upper portion of the channel component 444. In some embodiments, the liquid discharge device 440 may include the head tank 441 instead of the channel component 444.

Each of the liquid discharge devices 100, 100A, 100B, 440, 450, the head unit 550 and each of the printers 400 and 500 as the liquid discharge apparatus, which includes the liquid discharge head 1 described above, can attain the same operational effects as the operational effects of the liquid discharge head 1 described above. Although the liquid discharge head 1 is used in each of the above-described configurations, the liquid discharge head 2 may be used instead of the liquid discharge head 1. In this case, the same operational effects as those of the liquid discharge head 2 can be attained.

In embodiments of the present disclosure, the liquid to be used is not limited to a particular liquid as long as the liquid has a viscosity or surface tension to be discharged from a liquid discharge head. However, preferably, the viscosity of the liquid is not greater than 30 millipascal-second (mPa s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; or an edible material, such as a natural colorant. Such a solution, a suspension, or an emulsion can be used for, e.g., inkjet ink, surface treatment solution, or a material solution for three-dimensional fabrication.

Examples of an energy source for generating energy to discharge liquid include a piezoelectric actuator (a laminated piezoelectric element or a thin-film piezoelectric element), a thermal actuator that employs a thermoelectric transducer, such as a thermal resistor, and an electrostatic actuator including a diaphragm and opposed electrodes.

The pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and a counter electrode can be used.

The liquid discharge device is an assembly of parts relating to liquid discharge. The term “liquid discharge device” represents a structure including the liquid discharge head and a functional part(s) or unit(s) combined with the liquid discharge head as a single unit. For example, the liquid discharge device includes a combination of the liquid discharge head with at least one of a head tank, a carriage, a supply mechanism, a maintenance mechanism, a main-scanning moving mechanism, and a liquid circulation device.

The above integration may be achieved by, for example, a combination in which the liquid discharge head and a functional part(s) are secured to each other through, e.g., fastening, bonding, or engaging, and a combination in which one of the liquid discharge head and a functional part(s) is movably held by another. The liquid discharge head may be detachably attached to the functional part(s) or unit(s) each other.

The liquid discharge head and the head tank may be assembled, or the liquid discharge head and the head tank may be coupled (connected) to each other via, for example, a tube to form the liquid discharge device as a single unit. A unit including a filter may further be added to a portion between the head tank and the liquid discharge head of the liquid discharge device.

The liquid discharge device may be an integrated unit in which the liquid discharge head and the carriage are integrated as a single unit, or the liquid discharge head, the carriage, and the main-scanning moving mechanism are integrated as a single unit. As yet another example, the liquid discharge device is a unit in which the liquid discharge head and the main-scanning moving mechanism are combined into a single unit. The liquid discharge head is movably held by a guide that is a part of the main-scanning moving mechanism.

In still another example, the cap that forms a part of the maintenance mechanism is secured to the carriage mounting the liquid discharge head so that the liquid discharge head, the carriage, and the maintenance mechanism are integrated as a single unit to form the liquid discharge device. Further, in still yet another example, the liquid discharge device includes a tube connected to the liquid discharge head mounting the head tank or the channel component so that the liquid discharge head and the supply mechanism are integrated as a single unit. Through the tubes, the liquid in a liquid storage source is supplied to the liquid discharge head.

The main-scanning moving mechanism may be a guide only. The supply mechanism may be a tube(s) only or a loading unit only.

The liquid discharge device includes a head module including the above-described liquid discharge head, and a head unit with which the above-described functional components or mechanisms are combined to form a single unit.

The term “liquid discharge apparatus” used herein also represents an apparatus including the liquid discharge head, the liquid discharge device, the head module, or the head unit to drive the liquid discharge head to discharge liquid. The term “liquid discharge apparatus” used here includes, in addition to apparatuses to discharge liquid to a medium onto which liquid can adhere, apparatuses to discharge the liquid into gas (air) or liquid.

The liquid discharge apparatus may further include devices relating to feeding, conveying, and ejecting of the medium onto which liquid can adhere and also include a pretreatment device and an aftertreatment device.

The liquid discharge apparatus may be, for example, an image forming apparatus to form an image on a recording medium by discharging ink, or a three-dimensional fabrication apparatus to discharge fabrication liquid to a powder layer in which powder material is formed in layers to form a three-dimensional object.

The liquid discharge apparatus is not limited to an apparatus that discharges liquid to visualize meaningful images such as letters or figures. For example, the liquid discharge apparatus may be an apparatus that forms patterns having no meaning or an apparatus that fabricates three-dimensional images.

The term “medium onto which liquid can adhere” described above represents a medium onto which liquid is at least temporarily adhered, a medium onto which liquid is adhered and fixed, or a material into which liquid adheres and permeates. Examples of the medium onto which liquid can adhere include recording media, such as paper sheet, recording paper, recording sheet of paper, film, and cloth, electronic components, such as electronic substrate and piezoelectric element, and media, such as powder layer, organ model, and testing cell. The “medium onto which liquid can adhere” includes any material to which liquid adheres, unless otherwise specified.

Examples of the medium onto which liquid can adhere include any materials to which liquid can adhere even temporarily, such as paper, thread, fiber, fabric, leather, metal, plastic, glass, wood, and ceramic.

The liquid discharge apparatus relatively moves the liquid discharge head and the medium onto which liquid can adhere. Which of the liquid discharge head or the medium onto which liquid can adhere is moved is not limited. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The liquid discharge apparatus according to the present embodiment may also include an apparatus for manufacturing an electrode and an electrochemical element that is also referred to as an electrode manufacturing apparatus. The electrode manufacturing apparatus according to the present embodiment is described below.

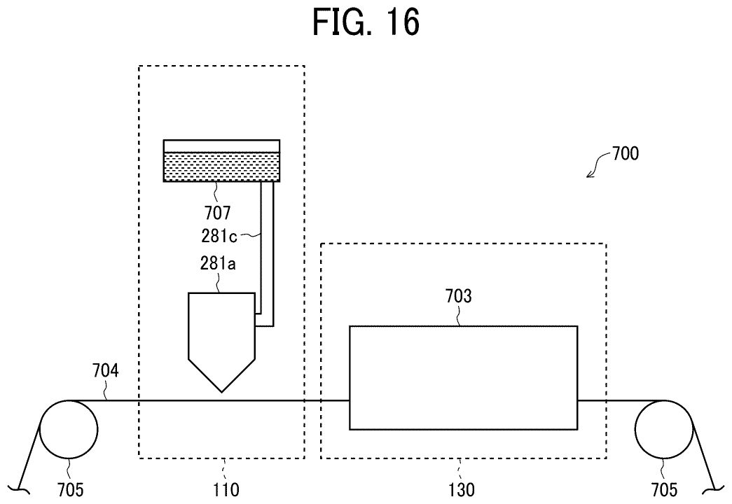

FIG. 16 is a schematic view of an example of an electrode manufacturing apparatus 700 according to an embodiment of the present embodiment. The electrode manufacturing apparatus 700 is an apparatus for manufacturing an electrode including a layer containing an electrode material by discharging a liquid composition using a liquid discharge device including a liquid discharge head.

First, a device and a process that form a layer containing an electrode material is described.

A liquid discharge device 110 that is provided for the electrode manufacturing apparatus 700 illustrated in FIG. 16 is the above-described liquid discharge device according to according to an embodiment of the present disclosure. A liquid discharge head 281a of the liquid discharge device 110 discharges a liquid composition. By so doing, the liquid composition is applied onto an object, and a liquid composition layer is formed on the object. The object, which may also be referred to simply as a discharge object in the following description, is not particularly limited and may be appropriately selected depending on the intended purpose, as long as the object is an object on which a layer containing an electrode material is formed. Examples of the object include an electrode substrate, i.e., a current collector, an active material layer, and a layer containing a solid electrode material. The object may be an electrode mixture layer containing an active material on an electrode substrate. The discharge device and a discharge process may be a device and a process of forming a layer containing an electrode material by directly discharging a liquid composition as long as the layer containing an electrode material can be formed on a discharge object. The discharge device and the discharge process may be a device and a process of forming a layer containing an electrode material by indirectly discharging a liquid composition.

Next, other configurations of the electrode manufacturing apparatus 700 and discharge processes are described.

Other configurations of the electrode manufacturing apparatus that manufactures an electrode mixture layer are not particularly limited and may be appropriately selected depending on the intended purpose, as long as the effects of embodiments of the present disclosure are not impaired. Other processes included in the method for producing an electrode mixture layer are not particularly limited and may be appropriately selected depending on the intended purpose, as long as the effects of the present embodiment are not impaired. For example, a heater and the heating process are examples of the configuration and the process included in the electrode manufacturing apparatus and the manufacturing method of the electrode mixture layer.

Next, the heater and the heating process are described.

A heater 703 that is provided for the electrode manufacturing apparatus for manufacturing an electrode mixture layer is a unit that heats the liquid composition discharged by the discharge device. The heating process included in the method for manufacturing an electrode mixture layer is a process of heating the liquid composition discharged in the discharging process. The liquid composition is heated to dry the liquid composition layer.

A description is given of a structure to form a layer containing electrode material by direct discharge of liquid composition. A description is given of an electrode manufacturing apparatus that forms an electrode mixture layer containing an active material on an electrode substrate, i.e., a current collector. As illustrated in FIG. 16, the electrode manufacturing apparatus 700 includes a discharge process unit 110 and a heating process unit 130. The discharge process unit 110 performs the discharge process in which the liquid composition is applied to a print base material 704 having the discharge object to form the liquid composition layer. The heating process unit 130 performs a heating process in which the liquid composition layer is heated to obtain the electrode composite layer.

The electrode manufacturing apparatus 700 includes a conveyor 705 to convey the print base material 704. The conveyor 705 conveys the print base material 704 via the discharge process unit 110 and the heating process unit 130 sequentially in this order at a preset speed. A method of producing print base material 704 having the discharge object such as an active material layer, is not limited to any particular method, and any method can be appropriately selected. The discharge process unit 110 includes, for example, the liquid discharge head 281a that performs an application process of applying the liquid composition onto the print base material 704, a storage container 281b that stores the liquid composition 707, and a supply tube 281c that supplies the liquid composition 707 stored in the storage container 281b to the liquid discharge head 281a.

The discharge process unit 110 discharges the liquid composition 707 from the liquid discharge head 281a so that the liquid composition 707 is applied onto the print base material 704 to form a liquid composition layer in a thin film shape. The storage container 281b may be integrated with an apparatus for manufacturing the electrode-mixture layer or may be detachable from the apparatus for manufacturing the electrode-mixture layer. The storage container 281b may be a container additionally attachable to a container integrated with the apparatus for manufacturing the electrode-mixture layer or a container detachable from the apparatus for manufacturing the electrode mixture layer.

The storage container 281b and the supply tube 281c can be selected as desired as long as the liquid composition 707 can be stably stored and supplied to the liquid discharge head 281a.

The heating process unit 130 performs a solvent removal process of heating and removing the solvent remaining in the liquid composition layer. Specifically, the solvent that remains in the liquid composition layer is heated and dried by the heater 703 of the heating process unit 130. By so doing, the solvent is removed from the liquid composition layer and the electrode mixture layer is formed. The solvent removal process in the heating process unit 130 may be performed under reduced pressure.

The heater 703 is not particularly limited and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to a boiling point of the solvent contained in the liquid composition 707 or the thickness of a formed film.

In the electrode-manufacturing apparatus 700, the liquid discharge head 281a similar to the liquid discharge head 1 or the liquid discharge head 2 described above is employed.

The electrode manufacturing apparatus 700 according to embodiments of the present disclosure is used to discharge the liquid composition onto a desired target position on the discharge object. The electrode mixture layer can be suitably used as, for example, a part of the configuration of an electrochemical element. The configuration of the electrochemical element other than the electrode mixture layer is not particularly limited, and any configuration can be appropriately selected. For example, as a configuration other than the electrode mixture layer, the electrochemical element may include, for example, a positive electrode, a negative electrode, and a separator.

Aspects of the present disclosure are, for example, as follows.

### First Aspect

A liquid discharge head includes a nozzle plate, a channel substrate to which the nozzle plate is bonded, and a piezoelectric element holding substrate. The nozzle plate includes multiple nozzles for discharging droplets. The channel substrate is partitioned by a partition wall and includes multiple individual channels communicating with the respective individual nozzles. The piezoelectric element holding substrate is bonded to a face of the channel substrate opposite the nozzle plate. An outer wall of an end partition wall which is the partition wall positioned at an end of the channel substrate is positioned at an inner position than an outer wall of an end on the one side of the piezoelectric element holding substrate.

### Second Aspect

In the liquid discharge head according to the first aspect, the width of the partition wall is equal to or larger than the width of another partition wall of the channel substrate, the another partition wall forming the multiple individual channels.

### Third Aspect

In the liquid discharge head according to the first or the second aspect, the distance between an outer wall of the end of the piezoelectric element holding substrate on the one side and an outer wall of the end partition wall is equal to or larger than a width of the end partition wall.

### Fourth Aspect

In the liquid discharge head according to any one of the first to third aspects, an outer wall of the end of the channel substrate on the one side is located at a similar position as an outer wall of the end of the piezoelectric element holding substrate on the one side except for the end partition wall.

### Fifth Aspect

A liquid discharge device includes the liquid discharge head according to any one of the first to fourth aspect.

### Sixth Aspect

A liquid discharge apparatus includes the liquid discharge device according to the fifth aspect.

### Seventh Aspect

A liquid discharge apparatus includes the liquid discharge head according to any one of the first to fourth aspect.

The above-described embodiments are illustrative and do not limit the present disclosure. Thus, numerous additional modifications and variations are possible in light of the above teachings. For example, elements and/or features of the embodiment and variation may be combined with each other and/or substituted for each other within the scope of the present disclosure.

The advantages achieved by the embodiments described above are examples and therefore are not limited to those described above.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A liquid discharge head comprising:
a nozzle plate having multiple nozzles, arrayed in a nozzle array direction, to discharge droplets;
a channel substrate having:
a first face bonded to the nozzle plate; and
a second face opposite to the first face,
the channel substrate including:
partition walls;
an end partition wall at an end of the channel substrate in the nozzle array direction; and
multiple individual channels partitioned by the partition walls and the end partition wall, the multiple individual channels respectively communicating with the multiple nozzles; and
a holding substrate bonded to the second face of the channel substrate, the holding substrate having a first outer wall at an end of the holding substrate in the nozzle array direction,
wherein the end partition wall has a second outer wall at the end of the channel substrate in the nozzle array direction, and
the second outer wall of the channel substrate is interior of the first outer wall of the holding substrate in the nozzle array direction.

2. The liquid discharge head according to claim 1,
wherein the end partition wall has a width equal to or larger than each widths of the partition walls.

3. The liquid discharge head according to claim 1,
wherein a distance between the first outer wall of the holding substrate and the second outer wall of the end partition wall is equal to or larger than a width of the end partition wall.

4. The liquid discharge head according to claim 1,
wherein the channel substrate has a third outer wall at each end of the channel substrate outside the second outer wall in a short direction intersecting the nozzle array direction, and
the third outer wall is disposed at the same position as the first outer wall of the holding substrate in the nozzle array direction.

5. A liquid discharge device comprising the liquid discharge head according to claim 1.

6. A liquid discharge apparatus comprising the liquid discharge device according to claim 5.

7. A liquid discharge apparatus comprising the liquid discharge head according to claim 1.
